(19) United States
(12) Patent Application Publication
(10) Pub. No.: US 2007/0097531 A1
(43) Pub. Date: May 3, 2007

(54) Optical devices

(75) Inventors: Li-Te Kuo, Hsinchu County (TW); Chau-Shin Jang, Hsinchu County (TW); Cheng-Yang Hsieh, Taipei City (TW); Mei-Lin Lai, Taichung County (TW); Shyh-Jier Wang, Hsinchu County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/338,337

(22) Filed: Jan. 23, 2006

Related U.S. Application Data
(63) Continuation-in-part of application No. 11/266,832, filed on Nov. 3, 2005.

(51) Int. Cl. G02B 7/02

(52) U.S. Cl. 359/823

(57) ABSTRACT

An optical device. A guide bar is connected to a base, with a first central axis in an optical axis direction of the optical device. A coil slides on the guide bar and has a second central axis in the optical axis direction and a first central elevation axis. The second central axis is perpendicular to the first central elevation axis. A fixed magnetic member is disposed in the coil and has a central magnetizing axis and a second central elevation axis. The central magnetizing axis is perpendicular to the second central elevation axis and aligned with the second central axis of the coil. The second central elevation axis is separated from the first central elevation axis. A lens housing is connected to the coil. When the coil is energized by application of a current, a magnetic force is generated, moving the coil and lens housing along the guide bar.

### CROSS REFERENCE TO RELATED APPILCATIONS

This application is a Continuation-In-Part of pending U.S. patent application Ser. No. 11/266,832, filed Nov. 3, 2005 and entitled “Optical devices”.

### BACKGROUND OF THE INVENTION

1. Field of the Invention

The invention relates to optical devices, and in particular to optical devices reducing power consumption.

2. Description of the Related Art

In some cameras, focusing of lenses is driven by voice coil motors. The voice coil motors provide faster driving and more precise positioning.

The Biot-Savart law, applied in operation of the voice coil motors, indicates that a conducting wire with a length L is subject to a force F when energized by an electric current I and located in a magnetic field with a magnetic flux B. The direction of the magnetic field is perpendicular to that of the electric current I. The magnitude of the force F equals IL×B, and the direction thereof is perpendicular to those of the electric current and magnetic field.

Referring to FIG. 1, a conventional lens module 1 comprises a fixed magnet 11, a movable coil 12, a lens housing (or lens) 13, a resilient arm 14, and a housing 15. The fixed magnet 11 is disposed in the movable coil 12. A central magnetizing axis of the fixed magnet 11 is aligned with a central axis of the movable coil 12, as indicated by line A of FIG. 1. The lens housing 13 is connected to the movable coil 12. The resilient arm 14 is connected between the housing 15 and the movable coil 12, supporting the movable coil 12 and lens housing 13. When the movable coil 12 is energized by application of a current, a magnetic force is generated by interaction between a magnetic field provided by the fixed magnet 11 and the current, moving the movable coil 12 along the central axis (line A) thereof. The lens housing 13 connected to the movable coil 12 is thus moved, and focusing or zooming operation can be performed.

Nevertheless, the lens module 1 has a few drawbacks. When the movable coil 12 and lens housing 13 move to a certain position, the resilient arm 14 is elastically deformed, thereby providing resilience. To maintain the lens housing 13 in the certain position, the movable coil 12 must be continuously energized by application of a holding current, generating a magnetic force to overcome the resilience. Accordingly, power consumption of the lens module 1 is considerable.

Further, during operation of the lens module 1, movement of the movable coil 12 is restricted. Namely, the movable coil 12 cannot move in a specific position. Specifically, when a central elevation axis of the movable coil 12 coincides with that of the fixed magnet 11, as indicated by line B of FIG. 1, no magnetic force is generated therebetween. Thus, the movable coil 12 and lens housing 13 cannot be held in the specific position, in which the central elevation axes of the movable coil 12 and fixed magnet 11 coincide. Accordingly, universal focusing and zooming of the lens module 1 are adversely affected.

Additionally, the larger the moving distance of the movable coil 12 (the larger the zoom range of a lens), the larger the length of the fixed magnet 11, increasing the size of the lens module 1.

Hence, there is a need for an optical device with reduced size and power consumption and increased zoom distance.

### BRIEF SUMMARY OF THE INVENTION

A detailed description is given in the following embodiments with reference to the accompanying drawings.

An exemplary embodiment of the invention provides an optical device comprising a base, a guide bar, a coil, a first fixed magnetic member, a second fixed magnetic member, and a lens housing. The guide bar is connected to the base and has a first central axis in an optical axis direction of the optical device. The coil slides on the guide bar and has a second central axis in the optical axis direction and a first central elevation axis. The second central axis is perpendicular to the first central elevation axis. The first fixed magnetic member is connected to the base and disposed in the coil. The first fixed magnetic member has a first central magnetizing axis and a second central elevation axis. The first central magnetizing axis is perpendicular to the second central elevation axis and aligned with the second central axis of the coil. The second central elevation axis is separated from the first central elevation axis. The second fixed magnetic member is disposed in the coil and separated from the first fixed magnetic member by a predetermined distance and has a second central magnetizing axis and a third central elevation axis. The first and second fixed magnetic members oppose each other with the same magnetic pole. The second central magnetizing axis is perpendicular to the third central elevation axis and aligned with the second central axis of the coil. The third central elevation axis is separated from the first central elevation axis. The first central elevation axis is between the second and third central elevation axes. The lens housing is connected to the coil. When the coil is energized by application of a current, a magnetic force is generated by interaction between the current and magnetic fields provided by the first and second fixed magnetic members, moving the coil and lens housing along the first central axis of the guide bar.

The optical device further comprises a position sensing member connected to the coil to detect movement of the coil.

The position sensing member comprises a Hall sensor, a reluctance sensor, or a photo interrupter.

The optical device further comprises a magnetic member and a metal plate. The metal plate is connected to the position sensing member. The magnetic member is connected to the base and opposes the metal plate. The coil is fixed to the guide bar by attraction between the magnetic member and the metal plate.

The optical device further comprises a magnetic-permeable member disposed between the first and second fixed magnetic members.

### BRIEF DESCRIPTION OF THE DRAWINGS

The invention can be more fully understood by reading the subsequent detailed description and examples with references made to the accompanying drawings, wherein:

FIG. 1 is a schematic cross section of a conventional lens module;

FIG. 2 is a schematic cross section of an optical device of a first embodiment of the invention; and

FIG. 3 is a schematic cross section of an optical device of a second embodiment of the invention.

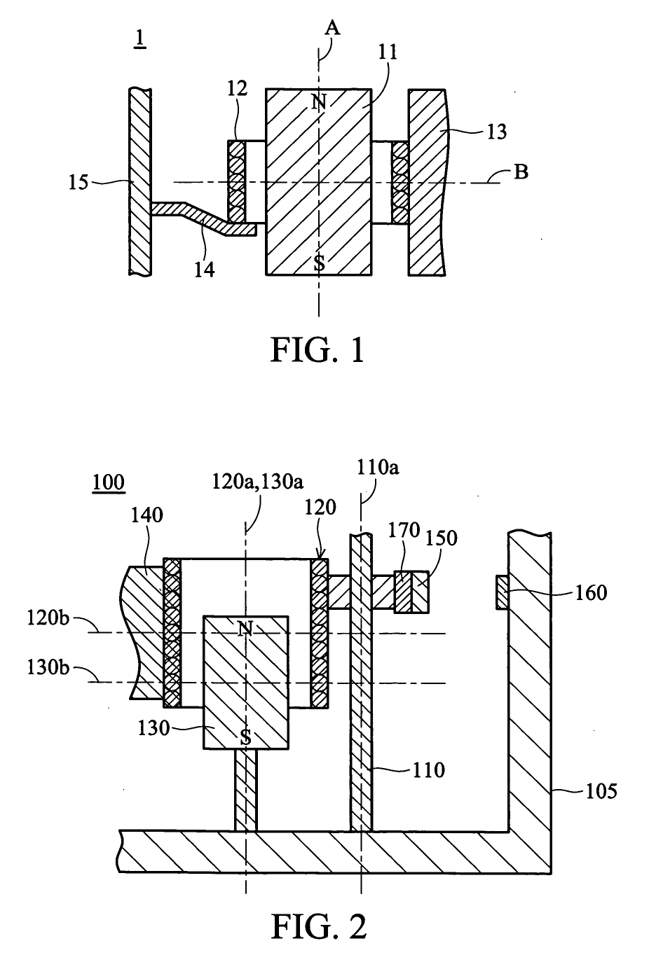

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

### First Embodiment

Referring to FIG. 2, the optical device 100 employs a solenoid principle and comprises a base 105, a guide bar 110, a coil 120, a fixed magnetic member 130, a lens housing 140, a position sensing member 150, a magnetic member 160, and a metal plate 170.

As shown in FIG. 2, the guide bar 110 is connected to the base 105 and has a first central axis 110a in an optical axis direction of the optical device 100. Namely, the first central axis 110a is parallel to the optical axis direction of the optical device 100.

The coil 120 slides on the guide bar 110 and has a second central axis 120a in the optical axis direction and a first central elevation axis 120b. Specifically, the second central axis 120a is perpendicular to the first central elevation axis 120b.

The fixed magnetic member 130 is connected to the base 105 and disposed in the coil 120. The fixed magnetic member 130 has a central magnetizing axis 130a and a second central elevation axis 130b. Specifically, the central magnetizing axis 130a is perpendicular to the second central elevation axis 130b and aligned with the second central axis 120a of the coil 120. More specifically, the second central elevation axis 130b is separated from the first central elevation axis 120b. Namely, no matter how the coil 120 moves, the first central elevation axis 120b thereof is separated from the second central elevation axis 130b of the fixed magnetic member 130. Moreover, the fixed magnetic member 130 may be a magnet, with two opposite polarities (N and S polarities) varying along the central magnetizing axis 130a.

The lens housing 140 is connected to the coil 120 and carries a lens (not shown). Specifically, connection between the lens housing 140 and the coil 120 is not limited to the configuration shown in FIG. 2.

The position sensing member 150 is connected to the coil 120, detecting the moving position or movement thereof. The position sensing member 150 may be a Hall sensor, a reluctance sensor, or a photo interrupter. The magnetic member 160 is connected to the base 105. The metal plate 170 is selectively connected to the position sensing member 150. The position sensing member 150 is disposed between the metal plate 170 and the magnetic member 160. The magnetic member 160 opposes the metal plate 170 and may be a magnet.

Being a Hall sensor, the position sensing member 150 can be selectively disposed in the coil 120 and oppose the fixed magnetic member 130, detecting changes in magnetic flux density and/or polarity of the magnetic field produced by the fixed magnetic member 130 and/or magnetic member 160. The moving position of the coil 120 can thus be obtained.

The following description is directed to operation of the optical device 100.

When the coil 120 is energized by application of a current, a magnetic force is generated by interaction between the current and the magnetic field provided by the fixed magnetic member 130, moving the coil 120 and lens housing 140 along the first central axis 110a of the guide bar 110. The lens carried by the lens housing 140 can thus perform focus and zoom operations. Additionally, by detection of the position sensing member 150, the coil 120 does not move to an ineffective position, in which the first central elevation axis 120b thereof coincides with the second central elevation axis 130b of the fixed magnetic member 130.

In another aspect, when moving to a specific position (the lens in the lens housing 140 reaches a focus position), the coil 120 and lens housing 140 are fixed to the guide bar 110 by attraction between the magnetic member 160 and the metal plate 170. At this point, no holding current is required to fix the coil 120 and lens housing 140, thus reducing power consumption of the optical device 100.

### Second Embodiment

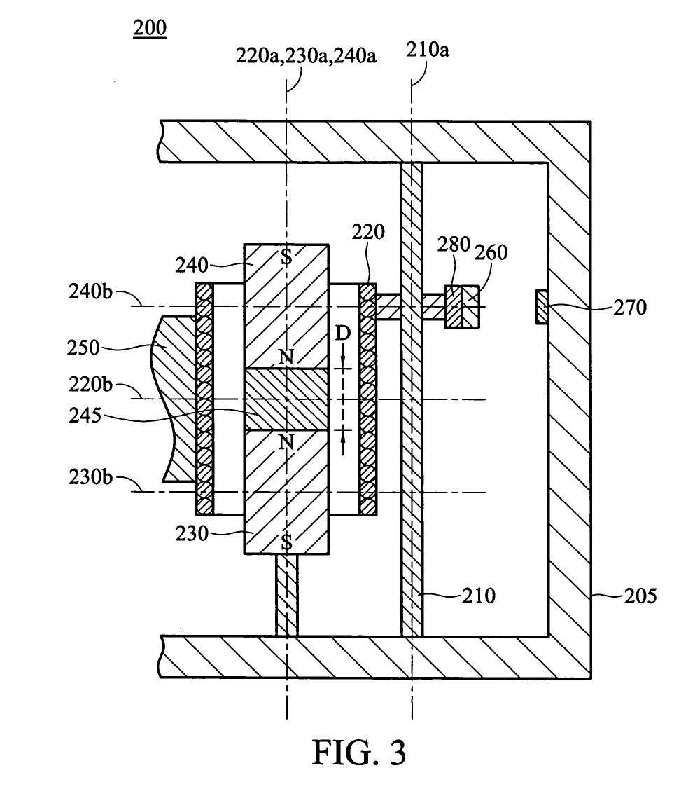

Referring to FIG. 3, the optical device 200 also employs the solenoid principle and comprises a base 205, a guide bar 210, a coil 220, a first fixed magnetic member 230, a second fixed magnetic member 240, a magnetic-permeable member 245, a lens housing 250, a position sensing member 260, a magnetic member 270, and a metal plate 280.

As shown in FIG. 3, the guide bar 210 is connected to the base 205 and has a first central axis 210a in an optical axis direction of the optical device 200. Namely, the first central axis 210a is parallel to the optical axis direction of the optical device 200.

The coil 220 slides on the guide bar 210 and has a second central axis 220a in the optical axis direction and a first central elevation axis 220b. Specifically, the second central axis 220a is perpendicular to the first central elevation axis 220b.

The first fixed magnetic member 230 is connected to the base 205 and disposed in the coil 220. The first fixed magnetic member 230 has a first central magnetizing axis 230a and a second central elevation axis 230b. Specifically, the first central magnetizing axis 230a is perpendicular to the second central elevation axis 230b and aligned with the second central axis 220a of the coil 220, and the second central elevation axis 230b is separated from the first central elevation axis 220b of the coil 220.

The second fixed magnetic member 240 is connected to the magnetic-permeable member 245, disposed in the coil 220 and separated from the first fixed magnetic member 230 by a predetermined distance D. Similarly, the second fixed magnetic member 240 has a second central magnetizing axis 240a and a third central elevation axis 240b. The second central magnetizing axis 240a is perpendicular to the third central elevation axis 240b and aligned with the second central axis 220a of the coil 220. The third central elevation axis 240b is separated from the first central elevation axis 220b of the coil 220. Specifically, the first central elevation axis 220b is between the second central elevation axis 230b and the third central elevation axis 240b. Namely, no matter how the coil 220 moves, the first central elevation axis 220b thereof is between the second central elevation axis 230b of the first fixed magnetic member 230 and the third central elevation axis 240b of the second fixed magnetic member 240. Moreover, the first fixed magnetic member 230 and second fixed magnetic member 240 may be magnets, with two opposite polarities (N and S polarities) varying along the first central magnetizing axis 230a and second central magnetizing axis 240a. Specifically, as shown in FIG. 3, the first fixed magnetic member 230 and second fixed magnetic member 240 oppose each other with the same magnetic pole,

The magnetic-permeable member 245 is disposed between the first fixed magnetic member 230 and the second fixed magnetic member 240, reducing repulsion therebetween. Moreover, the magnetic-permeable member 245 can effectively guide magnetic lines from the first fixed magnetic member 230 and second fixed magnetic member 240 into the coil 220.

The lens housing 250 is connected to the coil 220 and carries a lens (not shown). Similarly, connection between the lens housing 250 and the coil 220 is not limited to the configuration shown in FIG. 3.

The position sensing member 260 is connected to the coil 220, detecting the moving position or movement thereof. The position sensing member 260 may be a Hall sensor, a reluctance sensor, or a photo interrupter. The magnetic member 270 is connected to the base 205. The metal plate 280 is selectively connected to the position sensing member 260. The position sensing member 260 is disposed between the metal plate 280 and the magnetic member 270. The magnetic member 270 opposes the metal plate 280 and may be a magnet.

If a Hall sensor, the position sensing member 260 can be selectively disposed in the coil 220 and oppose the first fixed magnetic member 230 and/or the second fixed magnetic member 240, detecting changes in magnetic flux density and/or polarity of the magnetic field produced by the first fixed magnetic member 230 and/or second fixed magnetic member 240 and/or magnetic member 270. The moving position of the coil 220 can thus be obtained.

The following description is directed to operation of the optical device 200.

When the coil 220 is energized by application of a current, a magnetic force is generated by interaction between the current and magnetic fields provided by the first fixed magnetic member 230 and second fixed magnetic member 240, moving the coil 220 and lens housing 250 along the first central axis 210a of the guide bar 210. The lens carried by the lens housing 250 can thus perform focus and zoom operations. Additionally, by detection of the position sensing member 260, the coil 220 does not move to two ineffective positions, in which the first central elevation axis 220b thereof coincides with the second central elevation axis 230b of the first fixed magnetic member 230 and third central elevation axis 240b of the second fixed magnetic member 240.

Similarly, when moving to a specific position (the lens in the lens housing 250 reaches a focus position), the coil 220 and lens housing 250 are fixed to the guide bar 210 by attraction between the magnetic member 270 and the metal plate 280. At this point, no holding current is required to fix the coil 220 and lens housing 250, thus reducing power consumption of the optical device 200.

Moreover, the predetermined distance D between the first fixed magnetic member 230 and the second fixed magnetic member 240 can be adjusted. Specifically, when the predetermined distance D is relatively small, the coil 220 receives relatively high strength magnetic fields or magnetic flux density from the first fixed magnetic member 230 and second fixed magnetic member 240, thus increasing moving power. When the predetermined distance D, however, is relatively large, the distance between the second central elevation axis 230b and the third central elevation axis 240b is relatively large, thus increasing the moving distance or range of the coil 220.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical device, comprising:
a base;
a guide bar connected to the base, with a first central axis in an optical axis direction of the optical device;
a coil sliding on the guide bar, with a second central axis in the optical axis direction and a first central elevation axis, wherein the second central axis is perpendicular to the first central elevation axis;
a fixed magnetic member connected to the base and disposed in the coil, with a central magnetizing axis and a second central elevation axis, wherein the central magnetizing axis is perpendicular to the second central elevation axis and aligned with the second central axis of the coil, and the second central elevation axis is separated from the first central elevation axis; and
a lens housing connected to the coil, wherein, when the coil is energized by application of a current, a magnetic force is generated by interaction between the current and a magnetic field provided by the fixed magnetic member, moving the coil and lens housing along the first central axis of the guide bar.

2. The optical device as claimed in claim 1, further comprising a position sensing member connected to the coil to detect movement of the coil.

3. The optical device as claimed in claim 2, wherein the position sensing member comprises a Hall sensor, a reluctance sensor, or a photo interrupter.

4. The optical device as claimed in claim 1, further comprising a magnetic member and a metal plate, wherein the magnetic member is connected to the base and opposes the metal plate, and the coil is fixed to the guide bar by attraction between the magnetic member and the metal plate.

5. The optical device as claimed in claim 2, further comprising a magnetic member and a metal plate, wherein the metal plate is connected to the position sensing member, the magnetic member is connected to the base and opposes the metal plate, and the coil is fixed to the guide bar by attraction between the magnetic member and the metal plate.

6. An optical device, comprising:
a base;
a guide bar connected to the base, with a first central axis in an optical axis direction of the optical device;
a coil sliding on the guide bar, with a second central axis in the optical axis direction and a first central elevation axis, wherein the second central axis is perpendicular to the first central elevation axis;
a first fixed magnetic member connected to the base and disposed in the coil, with a first central magnetizing axis and a second central elevation axis, wherein the first central magnetizing axis is perpendicular to the second central elevation axis and aligned with the second central axis of the coil, and the second central elevation axis is separated from the first central elevation axis;
a second fixed magnetic member disposed in the coil and separated from the first fixed magnetic member by a predetermined distance, with a second central magnetizing axis and a third central elevation axis, wherein the first and second fixed magnetic members oppose each other with the same magnetic pole, the second central magnetizing axis is perpendicular to the third central elevation axis and aligned with the second central axis of the coil, the third central elevation axis is separated from the first central elevation axis, and the first central elevation axis is between the second and third central elevation axes; and
a lens housing connected to the coil, wherein, when the coil is energized by application of a current, a magnetic force is generated by interaction between the current and magnetic fields provided by the first and second fixed magnetic members, moving the coil and lens housing along the first central axis of the guide bar.

7. The optical device as claimed in claim 6, further comprising a position sensing member connected to the coil to detect movement of the coil.

8. The optical device as claimed in claim 7, wherein the position sensing member comprises a Hall sensor, a reluctance sensor, or a photo interrupter.

9. The optical device as claimed in claim 6, further comprising a magnetic member and a metal plate, wherein the magnetic member is connected to the base and opposes the metal plate, and the coil is fixed to the guide bar by attraction between the magnetic member and the metal plate.

10. The optical device as claimed in claim 7, further comprising a magnetic member and a metal plate, wherein the metal plate is connected to the position sensing member, the magnetic member is connected to the base and opposes the metal plate, and the coil is fixed to the guide bar by attraction between the magnetic member and the metal plate.

11. The optical device as claimed in claim 6, further comprising a magnetic-permeable member disposed between the first and second fixed magnetic members.
